(19) United States
(12) Patent Application Publication
(10) Pub. No.: US 2009/0325844 A1
(43) Pub. Date: Dec. 31, 2009

(54) Low Built, Anionic Detersive Surfactant-Containing Spray-Dried Powder that Additionally Comprises Clay

(76) Inventors: Hossam Hassan Tantawy, Northumberland (GB); Andrew Brian Greenaway Patton, Newcastle (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/475,793

(22) Filed: Jun. 1, 2009

(30) Foreign Application Priority Data
Jun. 25, 2008 (EP) 08 158 999.6

(51) Int. Cl. C11D 3/08; C11D 3/06

(52) U.S. Cl. 510/276

(57) ABSTRACT

The present invention relates to a spray-dried powder comprising: (a) anionic detersive surfactant; (b) from 0 wt % to 10 wt % zeolite builder; (c) from 0 wt % to 10 wt % phosphate builder; (d) at least 2 wt % water; (e) clay; and (f) optionally from 0 wt % to 20 wt % silicate salt.

### FIELD OF THE INVENTION

The present invention relates to spray-dried powder comprising clay. The spray-dried powder is suitable for incorporation into a laundry detergent composition. The spray-dried powder comprises anionic detersive surfactant, is low built, and additionally comprises clay.

### BACKGROUND OF THE INVENTION

There is a recent trend in the laundry detergent industry to produce low-built laundry powders. These are typically produced by a spray-drying process. However, the spray-drying processes to produce these low-built spray-dried powders have an unfavorable environmental profile and a poor rate capacity; they exhibit increased energy consumption compared to higher built, especially the more conventional zeolite and/or phosphate -built, spray-dried laundry powders.

The Inventors have overcome this problem by introducing clay into the spray-dried powder and by carefully controlling the moisture content of the spray-dried powder. The Inventors have found that the low built spray-dried powders of the present invention exhibit an improved environmental profile and increased production rate; the incorporation of clay into the spray-dried powder and controlling its moisture level reduces the energy consumption of the spray-drying process. The spray-dried particles of the present invention exhibit improved flowability profile.

### SUMMARY OF THE INVENTION

The present invention relates to a spray-dried powder as defined by claim 1.

### BRIEF DESCRIPTION OF THE DRAWING

FIG. 1 is directed to equipment set-up.

### DETAILED DESCRIPTION OF THE INVENTION

### Spray-Dried Powder

The spray-dried powder comprises (a) anionic detersive surfactant; (b) from 0 wt % to 10 wt % zeolite builder; (c) from 0 wt % to 10 wt % phosphate builder; (d) at least 2 wt % water; (e) clay; and (f) optionally from 0 wt % to 20 wt % silicate salt. The spray-dried particle may comprise carbonate salt. The spray-dried powder may comprise detergent adjunct ingredients.

Preferably, the spray-dried powder comprises at least 3 wt %, or at least 4 wt %, or at least 5 wt %, or at least 6 wt %, or at least 7 wt %, or at least 8 wt %, or at least 9 wt %, or even at least 10 wt % water. Preferably the weight ratio of water to clay present in the spray-dried powder is in the range of from at least 1:1, preferably at least 1.1:1, or at least 1.2:1, or at least 1.3:1, or at least 1.4:1, or at least 1.5:1, or at least 1.6:1, or at least 1.7:1, or at least 1.8:1, or at least 1.9:1, or even at least 2:1. By controlling the amount of water and/or controlling the weight ratio of water to clay present in the spray-dried particle, the environmental profile and the production rate of the spray-drying process are improved. In addition, the flowability, stability and physical properties of the spray-dried powder are also improved.

Preferably, the spray-dried powder comprises smectite clay, preferably di-octahedral smectite clay, and preferably montmorillonite clay. Preferably, the spray-dried powder comprises from 0.1 wt % to 30 wt % clay, preferably from lwt %, or from 2 wt %, or from 3 wt %, or from 4 wt %, or from 5 wt % clay, and preferably to 20 wt %, or to 15 wt % , or to 10 wt % clay.

Typically, the spray-dried powder has a bulk density in the range of from 50 g/l to 650 g/l, preferably from 100 g/l, or from 150 g/l, or from 200 g/l, and preferably to 500 g/l, or to 450 g/l, or even to 400 g/l. The method to determine the bulk density is described in more detail below.

Typically, the spray-dried particle has a particle size distribution such that the weight average particle size is in the range of from 350 micrometers to 850 micrometers, and preferably no more than 10 wt % of the spray-dried powder has a particle size greater than 1180 micrometers, and preferably no more than 10 wt % of the spray-dried particle has a particle size of less than 150 micrometers.

The spray-dried particle preferably has a cake strength of less than 3 kg, preferably from 0 kg to 1.5 kg. The method to determine the cake strength is described in more detail below.

### Anionic Detersive Surfactant

The anionic detersive surfactant preferably comprises alkyl benzene sulphonate, preferably the anionic detersive surfactant comprises at least 50%, preferably at least 55%, or at least 60%, or at least 65%, or at least 70%, or even at least 75%, by weight of the anionic detersive surfactant, of alkyl benzene sulphonate. The alkyl benzene sulphonate is preferably a linear or branched, substituted or unsubstituted, C₈₋₁₈ alkyl benzene sulphonate. This is the optimal level of the C₈₋₁₈ alkyl benzene sulphonate to provide a good cleaning performance. The C₈₋₁₈ alkyl benzene sulphonate can be a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548. Highly preferred C₈₋₁₈ alkyl benzene sulphonates are linear C₁₀₋₁₃ alkylbenzene sulphonates. Especially preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

The anionic detersive surfactant may preferably comprise other anionic detersive surfactants. A preferred anionic detersive surfactant is a non-alkoxylated anionic detersive surfactant. The non-alkoxylated anionic detersive surfactant can be an alkyl sulphate, an alkyl phosphate, an alkyl phosphonate, an alkyl carboxylate or any mixture thereof. The non-alkoxylated anionic surfactant can be selected from the group consisting of; C₁₀-C₂₀ primary, branched-chain, linear-chain and random-chain alkyl sulphates (AS), typically having the following formula:

CH₃(CH₂)ₓCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

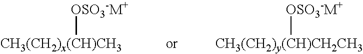

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS); and mixtures thereof.

Another preferred anionic detersive surfactant is an alkoxylated anionic detersive surfactant. The presence of an alkoxylated anionic detersive surfactant in the spray-dried powder provides good greasy soil cleaning performance, gives a good sudsing profile, and improves the hardness tolerance of the anionic detersive surfactant system. It may be preferred for the anionic detersive surfactant to comprise from 1% to 50%, or from 5%, or from 10%, or from 15%, or from 20%, and to 45%, or to 40%, or to 35%, or to 30%, by weight of the anionic detersive surfactant system, of an alkoxylated anionic detersive surfactant.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂₋₁₈ alkyl ethoxylated sulphate having an average degree of ethoxylation of from 1 to 10. Most preferably, the alkoxylated anionic detersive surfactant is a linear unsubstituted C₁₂₋₁₈ alkyl ethoxylated sulphate having an average degree of ethoxylation of from 3 to 7.

The alkoxylated anionic detersive surfactant, when present with an alkyl benzene sulphonate may also increase the activity of the alkyl benzene sulphonate by making the alkyl benzene sulphonate less likely to precipitate out of solution in the presence of free calcium cations. Preferably, the weight ratio of the alkyl benzene sulphonate to the alkoxylated anionic detersive surfactant is in the range of from 1:1 to less than 5:1, or to less than 3:1, or to less than 1.7:1, or even less than 1.5:1. This ratio gives optimal whiteness maintenance performance combined with a good hardness tolerance profile and a good sudsing profile. However, it may be preferred that the weight ratio of the alkyl benzene sulphonate to the alkoxylated anionic detersive surfactant is greater than 5:1, or greater than 6:1, or greater than 7:1, or even greater than 10:1. This ratio gives optimal greasy soil cleaning performance combined with a good hardness tolerance profile, and a good sudsing profile.

Suitable alkoxylated anionic detersive surfactants are: Texapan LEST™ by Cognis; Cosmacol AES™ by Sasol; BES151™ by Stephan; Empicol ESC70/U™; and mixtures thereof.

Preferably, the anionic detersive surfactant comprises from 0% to 10%, preferably to 8%, or to 6%, or to 4%, or to 2%, or even to 1%, by weight of the anionic detersive surfactant, of unsaturated anionic detersive surfactants such as alpha-olefin sulphonate. Preferably the anionic detersive surfactant is essentially free of unsaturated anionic detersive surfactants such as alpha-olefin sulphonate. By “essentially free of” it is typically meant “comprises no deliberately added”. Without wishing to be bound by theory, it is believed that these levels of unsaturated anionic detersive surfactants such as alpha-olefin sulphonate ensure that the anionic detersive surfactant is bleach compatible.

Preferably, the anionic detersive surfactant comprises from 0% to 10%, preferably to 8%, or to 6%, or to 4%, or to 2%, or even to 1%, by weight of alkyl sulphate. Preferably the anionic detersive surfactant is essentially free of alkyl sulphate. Without wishing to be bound by theory, it is believed that these levels of alkyl sulphate ensure that the anionic detersive surfactant is hardness tolerant.

### Zeolite Builder

The spray-dried powder typically comprises from 0% to 10 wt % zeolite builder, preferably to 9 wt %, or to 8 wt%, or to 7 wt %, or to 6 wt %, or to 5 wt %, or to 4 wt %, or to 3 wt %, or to 2 wt %, or to 1 wt %, or to less than 1% by weight of the spray-dried powder, of zeolite builder. It may even be preferred for the spray-dried powder to be essentially free from zeolite builder. By essentially free from zeolite builder it is typically meant that the spray-dried powder comprises no deliberately added zeolite builder. This is especially preferred if it is desirable for the spray-dried powder to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

### Phosphate Builder

The spray-dried powder typically comprises from 0% to 10 wt % phosphate builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the spray-dried powder, of phosphate builder. It may even be preferred for the spray-dried powder to be essentially free from phosphate builder. By essentially free from phosphate builder it is typically meant that the spray-dried powder comprises no deliberately added phosphate builder. This is especially preferred if it is desirable for the composition to have a very good environmental profile. Phosphate builders include sodium tripolyphosphate.

### Clay

Typically, the clay is selected from the group consisting of: allophane clays; chlorite clays, preferred chlorite clays are amesite clays, baileychlore clays, chamosite clays, clinochlore clays, cookeite clays, corundophite clays, daphnite clays, delessite clays, gonyerite clays, nimite clays, odinite clays, orthochamosite clays, pannantite clays, penninite clays, rhipidolite clays, sudoite clays and thuringite clays; illite clays; inter-stratified clays; iron oxyhydroxide clays, preferred iron oxyhydoxide clays are hematite clays, goethite clays, lepidocrite clays and ferrihydrite clays; kaolin clays, preferred kaolin clays are kaolinite clays, halloysite clays, dickite clays, nacrite clays and hisingerite clays; smectite clays; vermiculite clays; and mixtures thereof.

Preferably, the clay is a smectite clay. Preferred smectite clays are beidellite clays, hectorite clays, laponite clays, montmorillonite clays, nontonite clays, saponite clays and mixtures thereof. Preferably, the smectite clay may be a dioctahedral smectite clay. A preferred dioctahedral smectite clay is montmorillonite clay. The montmorillonite clay may be low-charge montmorillonite clay (also known as sodium montmorillonite clay or Wyoming-type montmorillonite clay). Typically, low-charge montmorillonite clay can be represented by the formula:

NaxA12−xMgxSi4O10(OH)2,

wherein, x is a number from 0.1 to 0.5, preferably from 0.2, and preferably to 0.4.

The montmorillonite clay may also be a high-charge montmorillonite clay (also known as a calcium montmorillonite clay or Cheto-type montmorillonite clay). Typically, high-charge montmorillonite clays can be represented by the formula:

CaxA12−xMgxSi4O10(OH)2,

wherein, x is a number from 0.1 to 0.5, preferably from 0.2, and preferably to 0.4.

Preferably, the smectite clay is a trioctahedral smectite clay. A preferred trioctahedral smectite clay is hectorite clay. Typically, hectorite clay can be represented by the following formula:

[(Mg3−xLix)Si4−yMeIIIy( )10(OH2−zFz)]−(x+y)((x+y)/n)Mn+,

wherein: y=0 to 0.4, if y=>0 then MeIII is AL, Fe or B, preferably y=0; and n is 1 or 2; and Mn+ is a monovalent (n=1) or a divalent (n=2) metal ion, preferably Mn+ is selected from the group Na, K, Mg, Ca and Sr; and x is a number from 0.1 to 0.5, preferably from 0.2, or from 0.25, and preferably to 0.4, or to 0.35; and z is a number form 0 to 2; and the value of x+y is the layer charge of the hectorite clay, preferably the value of x+y is from 0.1 to 0.5, preferably from 0.2, or from 0.25, and preferably to 0.4 or to 0.35.

Preferred hectorite clays have a cationic exchange capacity of at least 90 meq/100 g. Typically, the cationic capacity of clays are measured by the method described in Grimshaw, The Chemistry and Physics of Clays, 1971, Interscience Publishers Inc., pages 264-265. Especially preferred Hectorite clays are supplied by Rheox, and sold under the tradenames “Hectorite U” and “Hectorite R”.

The clay may be a light coloured crystalline clay mineral, preferably having a reflectance of at least 60, more preferably at least 70, or at least 80 at a wavelength of 460 nm. Preferred light coloured crystalline clay minerals are china clays, halloysite clays, dioctahedral clays such as kaolinite, trioctahedral clays such as antigorite and amesite, smectite and hormite clays such as bentonite (montmorillonite), beidilite, nontronite, hectorite, attapulgite, pimelite, mica, muscovite and vermiculite clays, as well as pyrophyllite/talc, willemseite and minnesotaite clays. Preferred light coloured crystalline clay minerals are described in GB2357523A and WO01/44425.

### Silicate Salt

The spray-dried powder optionally comprises from 0% to 20 wt % silicate salt, preferably to 15 wt %, or to 10 wt %, or even to 5% silicate salt. It may even be preferred for the spray-dried powder to be essentially free from silicate salt. By essentially free from silicate salt it is typically meant that the spray-dried powder comprises no deliberately added silicate. This is especially preferred in order to ensure that the spray-dried powder has a very good dispensing and dissolution profiles and to ensure that the spray-dried power provides a clear wash liquor upon dissolution in water. Silicate salts include water-insoluble silicates. Silicate salts include amorphous silicates and crystalline layered silicates (e.g. SKS-6). A preferred silicate salt is sodium silicate.

### Carbonate Salt

The spray-dried powder typically comprises carbonate salt, typically from 1% to 50%, or from 5% to 25% or from 10% to 20%, by weight of the spray-dried powder, of carbonate salt. A preferred carbonate salt is sodium carbonate and/or sodium bicarbonate. A highly preferred carbonate salt is sodium carbonate. Preferably, the spray-dried powder may comprise from 10% to 40%, by weight of the spray-dried powder, of sodium carbonate. However, it may also be preferred for the spray-dried powder to comprise from 2% to 8%, by weight of the spray-dried powder, of sodium bicarbonate. Sodium bicarbonate at these levels provides good alkalinity whilst minimizing the risk of surfactant gelling which may occur in surfactant-carbonate systems. If the spray-dried powder comprises sodium carbonate and zeolite, then preferably the weight ratio of sodium carbonate to zeolite is at least 15:1.

High levels of carbonate improve the cleaning performance of the composition by increasing the pH of the wash liquor. This increased alkalinity: improves the performance of the bleach, if present; increases the tendency of soils to hydrolyse, which facilitates their removal from the fabric; and also increases the rate, and degree, of ionization of the soils to be cleaned (n.b. ionized soils are more soluble and easier to remove from the fabrics during the washing stage of the laundering process). In addition, high carbonate levels improve the flowability of the spray-dried powder.

### Solid Laundry Detergent Composition

In another embodiment of the present invention, there is provided a solid laundry detergent composition. The solid laundry detergent composition is a fully formulated laundry detergent composition comprising a plurality of chemically different particle populations.

The solid laundry detergent composition comprises the spray-dried particle, described above. The solid laundry detergent composition may also comprise additional particles, such as anionic detersive surfactant agglomerates, dry-added bleach, such as sodium percarbonate particles, dry-added sodium carbonate particles, dry-added sodium sulphate particles, enzyme prills, perfume microcapsules, and perfume starch encapsulate particles. Perfume, non-ionic detersive surfactants, and/or other liquid detergent adjunct ingredients may be sprayed onto some or all of the particles present in the composition. The composition can be in any suitable form, such as free-flowing powder, tablet, unit dose form pouch form, typically being enclosed by a water-soluble film, such as polyvinyl alcohol. Typically, the solid laundry detergent composition comprises one or more adjunct detergent ingredients.

### Adjunct Detergent Ingredients

Suitable adjunct ingredients include: detersive surfactants such as anionic detersive surfactants, nonionic detersive surfactants, cationic detersive surfactants, zwitterionic detersive surfactants, amphoteric detersive surfactants; preferred nonionic detersive surfactants are C₈₋₁₈ alkyl alkoxylated alcohols having an average degree of alkoxylation of from 1 to 20, preferably from 3 to 10, most preferred are C₁₂₋₁₈ alkyl ethoxylated alcohols having an average degree of alkoxylation of from 3 to 10; preferred cationic detersive surfactants are mono-C₆₋₁₈ alkyl mono-hydroxyethyl di-methyl quaternary ammonium chlorides, more preferred are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride; source of peroxygen such as percarbonate salts and/or perborate salts, preferred is sodium percarbonate, the source of peroxygen is preferably at least partially coated, preferably completely coated, by a coating ingredient such as a carbonate salt, a sulphate salt, a silicate salt, borosilicate, or mixtures, including mixed salts, thereof; bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; enzymes such as amylases, carbohydrases, cellulases, laccases, lipases, oxidases, peroxidases, proteases, pectate lyases and mannanases; suds suppressing systems such as silicone based suds suppressors; fluorescent whitening agents; photobleach; filler salts such as sulphate salts, preferably sodium sulphate; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as alkoxylated polyamines and ethoxylated ethyleneimine polymers; anti-redeposition components such as carboxymethyl cellulose and polyesters; perfumes; sulphamic acid or salts thereof; citric acid or salts thereof; and dyes such as orange dye, blue dye, green dye, purple dye, pink dye, or any mixture thereof.

Preferably, the composition comprises less than 1 wt % chlorine bleach and less than 1 wt % bromine bleach. Preferably, the composition is essentially free from bromine bleach and chlorine bleach. By “essentially free from” it is typically meant “comprises no deliberately added”.

### Spray-Drying Process

In another embodiment of the present invention, a spray-drying process is provided. The spray-drying process prepares the spray-dried powder described above. The spray-drying process comprises the steps of (a) preparing an aqueous slurry comprising: (i) from above 0 wt % to less than 40 wt % water; and (ii) clay; and (b) spray-drying the aqueous slurry to form a spray-dried powder.

The spray-drying process is preferably operated in conditions whereby the air in-let temperature is in the range of from 250° C. to 290° C. Preferably the powder out-let temperature is less than 90° C. Preferably, the aqueous slurry is sprayed into the tower at a flow rate of from 10 kgmin⁻¹ to 20 kgmin⁻¹ per nozzle, and typically under a pressure of from 5×10⁶ to 9×10⁶ Pa.

### Aqueous Slurry

The aqueous slurry comprises: (i) from above 0 wt % to less than 40 wt % water; and (ii) clay. The aqueous slurry preferably comprises to 35 wt %, or to 30 wt %, or to 25 wt %, or to 20 wt %, or to 15 wt %, or even to 10 wt % water. Preferably the aqueous slurry comprises from 1 wt %, or from 2 wt %, or from 3 wt %, or from 4 wt %, or from 5 wt % water.

Preferably the aqueous slurry comprises from above 0 wt % to 10 wt % clay, preferably from 1 wt %, or from 2 wt %, or from 3 wt %, or from 4 wt %, and preferably to 9 wt %, or to 8 wt %, or to 7 wt % clay.

Preferably, the weight ratio of water to clay in the aqueous slurry is in the range of from 2:1 to 8:1.

The aqueous slurry typically comprises adjunct detergent ingredients. The aqueous slurry preferably comprises detersive surfactant, especially anionic detersive surfactant, carbonate salt, sulphate salt, polymeric material, and any combinations thereof.

### Method to Determine the Cake Strength

The cake strength is typically determined by the following method:

### Apparatus

### Cake Former

This cake formation apparatus is designed to produce a cylindrical cake of 6.35 cm in diameter and 5.75 cm in height.

| | |
|---|---|
| CYLINDER | Solid perspex, with polished surface. |
| | Diameter 6.35 cm |
| | Length 15.90 cm |
| | Base plate on end, diameter 11.40 cm, depth 0.65 cm |
| | 0.65 cm hole through the cylinder, with its centre 9.2 cm |
| | from the end opposite the base plate |
| SLEEVE | Hollow perspex, with polished inner surface |
| | Inner diameter 6.35 cm |
| | Wall thickness 1.50 cm |
| | Length 15.25 cm |
| LID | Perspex disc |
| | Diameter 11.5 cm |
| | Thickness 0.65 cm |
| LOCKING PIN | Stainless steel |
| | Diameter 0.6 cm |
| | Length 10 cm |
| WEIGHTS | 5 Kg to fit size of lid |
| | 10 kg, to fit size of lid |

### Force Recorder

| | |
|---|---|
| FORCE GAUGE | Either manual or electronic: battery/mains operated |
| | Max capacity 25 kg |
| | Graduations 0.01 kg |
| MOTORISED | Solid stand |
| STAND | Force gauge mounted on a block which moves in a |
| | vertical direction on a screw, driven by a |
| | reversible motor |
| | Rate of gauge descent = 54 cm/min |
| POWDER TRAY | For collection of powder from broken cake |
| STEEL RULE | For smoothing top of cake |

### Equipment Set-Up

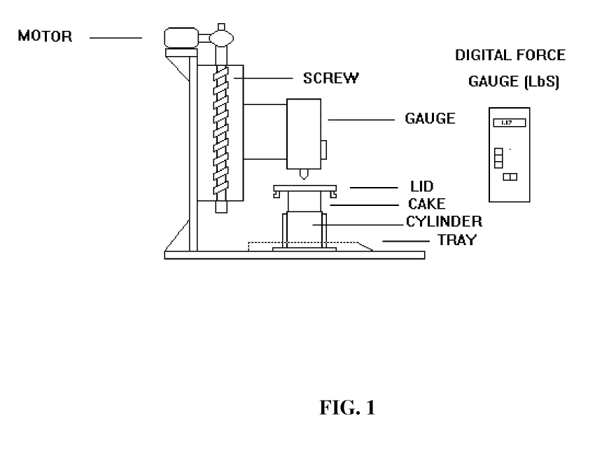

The Equipment Set-up is Illustrated in FIG. 1.

### Test Conditions

Conditioning: powder samples are stored at 35° C. for 24 hrs before testing. Test equipment is also at 35° C.

### Procedure

Step by Step Procedure

1> Place cake formation cylinder on a flat surface

2> Place the locking pin in the hole.

3> Slip on the cake formation sleeve and check that it moves freely

4> Pour in representative test material sample until the material overflows the cylinder sides

5> Level off granules with one smooth action using a steel rule or equivalent straight edge.

6> Place top plate on cylinder and centre by eye.

7> Place weight on top of assembly

8> Carefully, gently remove the restraining rod and start timer

9> Whilst cake is being formed move force meter to top position and zero it.

10> After two minutes, remove weight

11> Slide down cylinder so cake is completely exposed (leaving top plate remaining).

12> Gently place cake formation assembly under force meter

13> Centre assembly under force gauge by eye.

14> Start force meter apparatus so that it descends and breaks cake.

15> Read the maximum force (in Kgs) required to break the cake from the force meter dial.

16> Repeat least three times for each material and average the forces, this average is the mean cake strength for the material tested.

### Method for Determining the Bulk Density of a Powder

The bulk density is typically determined by the following method:

Summary: A 500 ml graduated cylinder is filled with a powder, the weight of the sample is measured and the bulk density of the powder is calculated in g/l.

### Equipment:

1. Balance. The balance has a sensitivity of 0.5 g.

2. Graduated cylinder. The graduated cylinder has a capacity 500 ml. The cylinder should be calibrated at the 500 ml mark, by using 500 g of water at 20° C. The cylinder is cut off at the 500 ml mark and ground smooth.

3. Funnel. The funnel is cylindrical cone, and has a top opening of 110 mm diameter, a bottom opening of 40 mm diameter, and sides having a slope of 76.40 to the horizontal.

4. Spatula. The spatula is a flat metal piece having of a length of at least 1.5 times the diameter of the graduated cylinder.

5. Beaker. The beaker has a capacity of 600 ml.

6. Tray. The tray is either a metal or plastic square, is smooth and level, and has a side length of at least 2 times the diameter of the graduated cylinder.

7. Ring stand.

8. Ring clamp.

9. Metal gate. The metal gate is a smooth circular disk having a diameter of at least greater than the diameter of the bottom opening of the funnel.

Conditions: The procedure is carried out indoors at conditions of 20° C. temperature, 1×10⁵Nm⁻² pressure and a relative humidity of 25%.

### Procedure:

1. Weigh the graduated cylinder to the nearest 0.5 g using the balance. Place the graduated cylinder in the tray so that it is horizontal with the opening facing upwards.

2. Support the funnel on a ring clamp, which is then fixed to a ring stand such that the top of the funnel is horizontal and rigidly in position. Adjust the height of the funnel so that its bottom position is 38 mm above the top centre of the graduated cylinder.

3. Support the metal gate so as to form an air-tight closure of the bottom opening of the funnel.

4. Completely fill the beaker with a 24 hour old powder sample and pour the powder sample into the top opening of the funnel from a height of 2 cm above the top of the funnel.

5. Allow the powder sample to remain in the funnel for 10 seconds, and then quickly and completely remove the metal gate so as to open the bottom opening of the funnel and allow the powder sample to fall into the graduated cylinder such that it completely fills the graduated cylinder and forms an overtop. Other than the flow of the powder sample, no other external force, such as tapping, moving, touching, shaking, etc, is applied to the graduated cylinder. This is to minimize any further compaction of the powder sample.

6. Allow the powder sample to remain in the graduated cylinder for 10 seconds, and then carefully remove the overtop using the flat edge of the spatula so that the graduated cylinder is exactly full. Other than carefully removing the overtop, no other external force, such as tapping, moving, touching, shaking, etc, is applied to the graduated cylinder. This is to minimize any further compaction of the powder sample.

7. Immediately and carefully transfer the graduated cylinder to the balance without spilling any powder sample. Determine the weight of the graduated cylinder and its powder sample content to the nearest 0.5 g.

8. Calculate the weight of the powder sample in the graduated cylinder by subtracting the weight of the graduated cylinder measured in step 1 from the weight of the graduated cylinder and its powder sample content measured in step 7.

9. Immediately repeat steps 1 to 8 with two other replica powder samples.

10. Determine the mean weight of all three powder samples.

11. Determine the bulk density of the powder sample in g/l by multiplying the mean weight calculated in step 10 by 2.0.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### A Spray-Dried Laundry Detergent Powder and Process of Making It

### Aqueous Alkaline Slurry Composition.

| | Aqueous slurry |
|---|---|
| Component | (parts) |
| Sodium silicate | 7.2 |
| Linear alkyl benzene sulphonate | 10.3 |
| Acrylate/maleate copolymer | 2.7 |
| Hydroxyethane di(methylene phosphonic acid) | 0.5 |
| Sodium carbonate | 7.4 |
| Sodium sulphate | 36.3 |
| Montmorillonite clay | 6.5 |
| Water | 27.3 |
| Miscellaneous, such as magnesium sulphate, | Balance to |
| and one or more stabilizers | 100 parts |
| Total Parts | 100.00 |

### Preparation of a Spray-Dried Laundry Detergent Powder.

An alkaline aqueous slurry having the composition as described above is prepared in a slurry making vessel (crutcher) having a moisture content of 27.3%. The aqueous slurry pumped under pressure (5×10⁵Nm⁻²), into a counter current spray-drying tower with an air inlet temperature of from 275° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust the exhaust air in the spray-drying tower and collected in a post tower containment system. The spray-dried powder has a moisture content of 5.0 wt %, a bulk density of 430 g/l and a particle size distribution such that greater than 90 wt % of the spray-dried powder has a particle size of from 150 to 710 micrometers. The composition of the spray-dried powder is given below.

### Spray-Dried Laundry Detergent Powder Composition.

| | % w/w Spray |
|---|---|
| Component | Dried Powder |
| Sodium silicate salt | 8.9 |
| Linear alkyl benzene sulphonate | 13.4 |
| Acrylate/maleate copolymer | 3.5 |
| Hydroxyethane di(methylene phosphonic acid) | 0.6 |
| Sodium carbonate | 10.8 |
| Sodium sulphate | 47.6 |
| Montmorillonite clay | 8.5 |
| Water | 5.0 |
| Miscellaneous, such as magnesium sulphate, | 1.7 |
| and one or more stabilizers | |
| Total Parts | 100.00 |

### A Granular Laundry Detergent Composition.

| | % w/w |
|---|---|
| | granular |
| | laundry |
| | detergent |
| Component | composition |
| Spray-dried powder of example 1 (described above) | 59.38 |
| 91.6 wt % active linear alkyl benzene sulphonate flake | 0.22 |
| supplied by Stepan under the tradename Nacconol | |
| 90G ® | |
| Citric acid | 5.00 |
| Sodium percarbonate (having from 12% to 15% | 14.70 |
| active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate (92 wt % active) | 4.35 |
| Suds suppressor agglomerate (11.5 wt % active) | 0.87 |
| Acrylate/maleate copolymer particle (95.7 wt % active) | 0.29 |
| Green/Blue carbonate speckle | 0.50 |
| Sodium Sulphate | 12.59 |
| Solid perfume particle | 0.63 |
| Total Parts | 100.00 |

The above laundry detergent composition was prepared by dry-mixing all of the above particles in a standard batch mixer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A spray-dried powder comprising:
(a) anionic detersive surfactant;
(b) from 0 wt % to 10 wt % zeolite builder;
(c) from 0 wt % to 10 wt % phosphate builder;
(d) at least 2 wt % water;
(e) clay; and
(f) optionally from 0 wt % to 20 wt % silicate salt.

2. A powder according to claim 1, wherein the powder comprises at least 5 wt % water.

3. A powder according to claim 1, wherein the powder comprises montmorillonite clay.

4. A powder according to claim 1, wherein the powder comprises from 1 wt % to 10 wt % clay.

5. A powder according to claim 1, wherein:
(a) the powder comprises at least 5 wt % water; and
(b) the powder comprises from 1 wt % to 10 wt % of montmorillonite clay.

6. A solid laundry detergent composition comprising spray-dried powder according to claim 1.
